(19) United States
(12) Patent Application Publication
(10) Pub. No.: US 2019/0010360 A1
(43) Pub. Date: Jan. 10, 2019

(54) CONNECTING OF SEALING STRIPS

(71) Applicant: SIKA TECHNOLOGY AG, Baar (CH)

(72) Inventors: Markus HAUFE, Zürich (CH); Max HUG, Zürich (CH)

(73) Assignee: SIKA TECHNOLOGY AG, Baar (CH)

(21) Appl. No.: 15/576,748

(22) PCT Filed: Jun. 2, 2016
(86) PCT No.: PCT/EP2016/062552

§ 371 Date: Nov. 24, 2017

(30) Foreign Application Priority Data
Jun. 10, 2015 (EP) 15171397.1

(51) Int. Cl. C09J 5/02; E04B 1/68

(52) U.S. Cl. CPC C09J 5/02; E04B 1/6806; C09J 2433/00; C09J 2423/166; C09J 2423/168; C09J 2415/008; C09J 2427/008; C09J 2409/006; C09J 2409/008; C09J 2415/006; C09J 2427/006

(57) ABSTRACT

A method for connecting sealing strips, includes at least one latent alkyl borane and is substantially free of decomplexing agent for the latent alkyl borane, to a sealing-strip substrate (1), applying a radical-curing adhesive to the sealing-strip substrate (1) pre-treated with the latent alkyl borane, bringing the sealingstrip substrate (1) in contact with a sealing-strip substrate (2) in such a way that the radical-curing adhesive is arranged between the two substrates, and allowing the radical-curing adhesive to cure, a composite structure thus being fonned. The method for adhesively bonding sealing strips based on elastic and thennoplastic substrates, such as EPDM or SBR, but also for adhesively bonding PVC sealing strips. Sealing strips adhesively bonded accordingly are characterized by favorable resistance of the adhesive to alkaline media, wherein conventional adhesives can be used which have optimized properties with regard to the storage stability, the open time, and the curing time thereof.

### TECHNICAL FIELD

The present invention relates to a method for connecting joining strips, comprising a) applying a composition which comprises at least one latent alkylborane and is substantially free of decomplexing agents for the latent alkylborane to a joining strip substrate (1), b) applying a radically curable adhesive to the joining strip substrate (1) pretreated with the latent alkylborane, c) contacting the joining strip substrate (1) from b) with a joining strip substrate (2) such that the radically curable adhesive is disposed between the two substrates, and d) allowing the radically curable adhesive to cure to form a composite structure. The present invention likewise relates to joining strips bonded by the method described above.

By treating joining strip substrates which, like EPDM or SBR, for example, contain unsaturated units, with a latent alkylborane, subsequent connecting of a radically curable adhesive to the surface of these substrates is substantially promoted, and so the method can be used in particular for the bonding of joining strip substrates on the basis of joining strip materials which have unsaturated units.

### PRIOR ART

Joining strips are used in connection with concrete constructions for the purpose of sealing to prevent penetration of water. In order to ensure complete sealing, individual joining strip ends must be connected, for which, in general, joining by welding by means of electrically heatable heating mirrors is employed. A problem with welding joining strips, however, is that these methods are relatively time-consuming and complicated and that a certain infrastructure is necessary, in the form of welding equipment and required power, for example. Furthermore, the welding of joining strips is relatively susceptible to faults, meaning that the joining has to be performed by trained personnel.

A further problem is that the weldability of different joining strip materials varies, and so the success of the connection is also dependent on the material used. Against the background of these problems, there is a need for a method for connecting joining strips that can be performed relatively simply and quickly and can be implemented using simple means.

EP 1 176 170 describes a method for bonding sealing sheets using epoxy adhesives, wherein the sealing sheets are to comprise a thermoplastic polymer having at least one reactive epoxy function. As a result of the attachment of the epoxy functions in the sealing sheet to the epoxy adhesive, pretreatment of the sheet with an adhesion promoter is said to be dispensable.

EP 1 029 906 describes organoboranes and organoborane-amine complexes for use as pretreatment agents for substrates having low surface energy such as polyethylene, polypropylene or polytetrafluoroethylene (PTFE). Besides the organoboranes or organoborane-amine complexes, the compositions described in EP 1 029 906 may usefully comprise acrylate monomers, acids, and optionally solvents.

Whereas the use of adhesive systems for the connecting of identical or different substrates is already well-established in the art, a problem which frequently occurs, particularly in the case of the elastic substrates with low surface tension, is that of inadequate attachment and adhesion of applied adhesives to the substrate. In particular, materials based on unsaturated units, such as elastomers, in the form of EPDM, NBR or SBR, for example, have emerged as being substrates which are relatively difficult to bond, since the adhesion to these materials of the majority of adhesives and in particular of many acrylate adhesives is inadequate.

For these reasons, there has yet been no method established for the connecting of joining strips that is based on an adhesive system. Other problems which may be referred to in this connection include the necessary rapidity of curing and the stability at high pH levels, since in the course of further processing operations, joining strips frequently come into contact with fresh (and therefore highly alkaline) concrete and with highly alkaline concrete pore liquid.

The present invention engages with these problems.

### DESCRIPTION OF THE INVENTION

A first aspect of the present invention relates to a method for connecting joining strips, comprising a) applying a composition which comprises at least one latent alkylborane and is substantially free of decomplexing agents for the latent alkylborane to a joining strip substrate (1), b) applying a radically curable adhesive to the joining strip substrate (1) pretreated with the latent alkylborane, c) contacting the joining strip substrate (1) from b) with a joining strip substrate (2) such that the radically curable adhesive is disposed between the two substrates, and d) allowing the radically curable adhesive to cure to form a composite structure.

When it is said above that the composition is substantially free of decomplexing agents for the latent alkylborane, this should be interpreted to mean that the composition has preferably less than 5 wt %, more preferably less than 2 wt %, and very preferably no detectable amounts of decomplexing agents.

A “decomplexing agent”, as this term is used here, is a compound which, on contact with the latent alkylborane, transforms it into an active alkylborane—for example, in that an adduct of the decomplexing agent is formed with the amine from an alkylborane-amine complex with release of alkylborane. Following reaction with the decomplexing agent, an alkylborane is formed which under polymerization conditions is present as a free radical or generates free radicals. For examples of suitable decomplexing agents, reference is made to the observations below.

A latent alkylborane for the purposes of the present invention means an alkylborane which is present in a form in which formation of radicals is not favored. This may be the case, for example, with the fourth coordination site of the boron not being blocked by a substituent, but instead, for example, binding the free electron pair of a nitrogen or oxygen. The latent alkylborane is present preferably in tetracoordinated structure. From the latent alkylborane it is possible for an active species to form, for example, by removal of a ligand by dissociation, producing a free coordination site on the boron.

In one preferred embodiment of the method described above, the joining strip substrate comprises a PVC, EPDM, NBR or SBR substrate, or comprises a substrate composed of mixtures of these materials such as PVC/NBR. Particularly suitable substrates are EPDM, NBR or SBR substrates. If reference is made above to PVC, EPDM, NBR or SBR substrates, this should be understood to mean that the material stated forms the thermoplastic or elastic basis of the substrate, but that in addition to this material there may be other constituents present such as fillers, plasticizers, etc. The substrate ought, furthermore, usefully to have an elasticity modulus, determined according to DIN 53457, of <1000 MPa, preferably in the range from 1 to 250 MPa and more preferably 5 to 60 MPa.

It is further preferred for the joining strip substrate to consist of the stated materials and also customary adjuvants for such materials (e.g., plasticizers in the case of PVC, or colorants and fillers).

In the context of the method described, it is useful for the composition with the latent alkylborane to be applied to the joining strip substrate (2) as well before step c), in order to improve the attachment of the radically curable adhesive there as well.

The radically curable adhesive comprises, in particular, an adhesive based on acrylates, styrene or alkylstyrenes, or unsaturated polyesters. In one preferred embodiment the radically curable adhesive is an acrylate-based adhesive, i.e., an adhesive based on (meth)acrylates. It has been found that commercially available acrylate adhesives, when used in the method described above, ensure effective connection to joining strip substrates. In contrast to this, with adhesives whose curing is not based on a radical process (such as polyurethane or epoxy adhesives, for example), no improvement in adhesion is observed as a result of pretreatment with a composition comprising at least one latent alkylborane.

Without being tied to any particular theory, it is assumed that as a result of applying the latent alkylborane, in particular to substrates which contain unsaturated units, in the form of C═C double bonds, for example (EPDM or SBR substrates, for example), the unsaturated units react with the active species of the alkylborane, or with radicals generated by the active species, and therefore the substrate is incorporated into the polymerization of the radically curable adhesive.

In the context of the present invention, the composition comprises at least one latent alkylborane. This latent alkylborane is capable of forming trivalent alkylboranes.

Preferred latent alkylboranes are tetravalent compounds which have four bonds to the boron, of which three are covalent and one is in the form of an electronic association with an electron donor, preferably an amine. From the complex, a species which generates free radicals is formed, in the form of a trivalent alkylborane. This reaction is promoted if the latent alkylborane comes into contact with a further substance, which is referred to below as decomplexing agent or initiator. The species generating free radicals produces free radicals by reaction with oxygen from the surroundings.

Preferred latent alkylboranes are alkyl borates (e.g. alkyl borate salts) or alkylborane complexes (for example, alkylborane-amine complexes). An alkyl borate is a salt of a positive cation and an anionic tetravalent boron. Any alkyl borate which on contact with a decomplexing agent can be transformed into an alkylborane can be used in the context of the present invention. One class of preferred alkylborates (likewise known under the designation “quaternary boron salts”) is disclosed for example in Kneafsey et al., US 2003/0226472, and Kneafsey et al., US 2004/0068067, both of which are hereby incorporated by reference.

In a further embodiment, the alkyl borate is an internally blocked borate, as described for example in Kendall et al., U.S. Pat. No. 6,630,555, and which is hereby incorporated by reference. Described in that document are internally blocked borates with fourfold coordination, with the boron atom being part of a ring structure which additionally has oxa and thio functionalities. In connection with alkyl borates of the kind described here, the term “internally blocked” designates a boron species with fourfold coordination which is part of an internal ring structure which comprises two of the four boron coordination sites. The internal blocking includes a structure having one or more rings, and the boron atom is part of structures having one or more rings.

Particularly preferred borates for the purposes of the present invention are the alkali metal salts, especially the potassium salts, of tri-n-butylboron tert-butoxide, tri-sec-butylboron tert-butoxide, and of diethylisopropyloxyboron tert-butoxide. Another preferred borate is lithium tri-sec-butylborohydride, which is available, for example, under the tradename Calselect® LI from BASF.

Further latent alkylboranes to be used usefully in the context of the present invention are dialkylboron compounds, such as, for example, diethylmethoxyborane, diethylisopropyloxyborane, the methylaminoethanol complex of diethylisopropyloxyborane, and methylaminoethoxydicyclohexyl-borane.

In one preferred embodiment the latent alkylborane is in the form of an alkylborane-amine complex. In this case the species which generates free radicals is a trialkylborane or an alkylcycloalkylborane (i.e., the alkylborane-amine complex may comprise a trialkylborane or an alkylcycloalkylborane). Preferred such boranes conform to the formula B—(R¹)₃, where B is boron and R¹ independently at each occurrence may be a C₁-C₁₀ alkyl group or a C₃-C₁₁ cycloalkyl group, or two or more of R¹ may be present in the form of a cycloaliphatic ring. Preferably R¹ is a C₁-C₆ alkyl group, more preferably a C₁-C₄ alkyl group, and most preferably a C₁-C₃ alkyl group. Among the preferred alkylboranes are triethylborane, triisopropylborane, and tri-n-butylborane. If the latent alkylborane takes the form of an alkylborane-amine complex, the alkylborane is a trivalent alkylborane, while the amine may be any amine which forms a complex reversibly with the borane.

Alkylborane-amine complexes which can be used for the purposes of this invention have the general formula B(—R¹)₃AM, where R¹ independently at each occurrence may be a C₁-C₁₁ alkyl or C₃-C₁₀ cycloalkyl group, or where two or more R¹s may form a cycloaliphatic ring. Preferably R¹ is a C₁₋₆ alkyl group, more preferably C₁-C₄ alkyl group, and most preferably C₂-C₄ alkyl group. Examples of particularly preferred alkylboranes are triethylborane, triisopropylborane, and tri-n-butylborane. Of these, the boranes with relatively long-chain alkyl radicals, such as tri-n-butylborane, are the most preferred. AM stands for an amine radical.

The amine which is bonded in the alkylborane-amine complex in accordance with the present invention may be any amine or any mixture of amines that forms a complex with the alkylborane, it being possible for the complex to be cleaved. This cleaving may proceed spontaneously, or else, however, may be accelerated by addition of a decomplexing agent or by elevated temperatures. The attractiveness of using a particular amine in an alkylborane-amine complex may be calculated from the energy difference between the Lewis acid-base complex and the sum total of the energies of the isolated Lewis acids (alkylborane) and bases (amine), known as binding energy, as is disclosed for example in Jialanella et al., U.S. Pat. No. 7,247,596, column 5, line 60 to column 6, line 28. Furthermore, account should also be taken of the toxic potential of the amine.

Binding energy=−[complex energy−(energy of Lewis acid+energy of Lewis base)]

Preferred amines include ammonia, primary or secondary amines, or polyamines which contain primary or secondary amine groups, as are described in U.S. Pat. No. 5,539,070 in column 5, lines 41 to 53, U.S. Pat. No. 5,106,928 in column 2, lines 29 to 58, or in U.S. Pat. No. 5,686,544 in column 7, line 29 to column 10, line 36. They include ethanolamine, secondary dialkyldiamines or polyoxyalkylenepolyamines, amine-terminated reaction products of diamines and compounds which have one or more groups that are reactive with amines. Compounds of this kind are disclosed for example in U.S. Pat. No. 5,883,208 in column 7, line 30 to column 8, line 56. With a view to the reaction products disclosed in U.S. Pat. No. 5,883,208, they preferably comprise diprimary amines such as alkyl-diprimary amines, aryl-diprimary amines, alkylaryl-diprimary amines, and polyoxyalkylene-diamines. Particularly preferred amines encompass N-octylamine, 1,6-diaminohexane (1,6-hexanediamine), diethylamine, dibutylamine, diethylenetriamine, dipropylenetriamine, 1,3-propylenediamine (1,3-propanediamine), 1,2-propylenediamine, 1,2-ethanediamine, 1,5-pentanediamine, 1,12-dodecanediamine, 2-methyl-1,5-pentanediamine, 3-methyl-1,5-pentanediamine, triethylenetetraamine, and diethylenetriamine. Preferred polyoxyalkylene-polyamines encompass polyethylene oxide diamine, polypropylene oxide diamine, triethylene glycol propylene diamine, polytetramethylene oxide diamine, and polyethylene oxide-copolypropylene oxide diamine.

The amine in the organoborane-amine complex is preferably in the form of an alkyldiamine having at least one primary amino group, it being particularly preferred if the alkyl group contains 2 to 6 carbon atoms and more particularly 2 to 4 carbon atoms.

In one particularly preferred embodiment, the alkylborane-amine complex comprises a trialkylborane or an alkylcycloalkylborane, and the amine comprises a primary amine, a secondary amine, a polyamine having primary or secondary amino groups or both, ammonia, a polyoxyalkyleneamine, the reaction product of a diamine and a difunctional compound which has groups which react with amines, where the reaction product contains terminal amine groups, an arylamine, a heterocyclic amine, a compound having a structural amidine unit, an aliphatic heterocycle which has at least one secondary nitrogen atom in the heterocyclic ring, where the heterocycle may contain one or more secondary or tertiary nitrogen atoms, oxygen atoms, sulfur atoms or double bonds in the heterocycle, alicyclic compounds which, bonded to the alicyclic ring, have one or more substituents which contain an amine group, conjugated imines, or mixtures thereof.

Alkylborane-amine complexes especially preferred in the context of this invention are the triethylborane-diaminopropane complex, the triethylborane-diethylenetriamine complex, the tri-n-butylborane-methoxypropylamine complex, the tri-n-butylborane-diaminopropylamine complex, the tri-sec-butyl-borane-diaminopropane complex, the methylaminoethoxy-diethylborane complex, and the methylaminoethoxy-dicyclohexylborane complex. Of these, the tri-n-butylborane-methoxypropylamine complex is the most preferred in the context of the present invention.

In the context of the present invention it is preferred if the composition comprising the at least one latent alkylborane has a pH of approximately 7 or more, preferably a pH of 7 to 12, and especially preferably a pH of 7 to 10.

It is useful if the composition comprising at least one latent alkylborane further comprises a solvent, it being necessary for this solvent to have sufficient solubility for the latent alkylborane, so that the latter is present in solution in the solvent. Particularly suitable solvents in combination with latent alkyboranes in accordance with the present invention include hexane, heptane, xylene, ethyl acetate or mixtures thereof. Of these, ethyl acetate is the most preferred on toxicological grounds.

Regarding the concentration of the latent alkylborane in the composition, the present invention is not subject to any relevant restrictions. All that is necessary is that the latent alkylborane be present in the composition in an amount which brings about a marked improvement in the connection of the substrate to the radically curable substance. The latent alkylborane is present in the composition preferably in an amount of approximately 0.05 to 50 wt %, more particularly 1 wt % to 40 wt %, with particular preference from approximately 2.5 to 30 wt %, and even more preferably from 2.5 to 20 wt %, and most preferably 5 to 10 wt %. It has emerged that an amount of just 2.5 wt % of latent alkylboranes achieves a significant improvement in the torsional strength in MPa, whereas at amounts of 15 to 30 wt % the results are only insignificantly better than at lower concentrations of the latent alkylborane.

It has emerged, furthermore, that the addition of a radically curable monomer to the latent alkylborane may further improve the adhesion to the substrate. Suitable radically curable monomers in this context are, in particular, (meth)acrylates as described below for the radically curable substance. All that is required of these (meth)acrylates is that they do not have any decomplexing properties—in other words, among other considerations, that they have no carboxyl groups, and that they are preferably liquid and can be dissolved effectively in the solvent for the latent alkylborane. Particularly preferred (meth)acrylates are, for example, methacrylates such as tetrahydrofurfuryl methacrylate, amino methacrylates such as dimethylaminoethyl methacrylate, and benzyl methacrylate. Mixtures of the stated (meth)acrylates may likewise be used. The ratio of the additional radically curable monomers to the latent alkylborane (based on their weight in each case) is not critical, but is preferably in the range from 100:1 to 1:5, more particularly 10:1 to 1:5, more preferably 5:1 to 1:5, even more preferably 3:1 to 1:3, and most preferably between 2:1 and 1:2. Based on the amount of the radically curable monomer in the composition comprising the latent alkylborane, it is further preferred if the total amount of radically curable monomers in the composition is not more than 30 wt %, more particularly not more than 20 wt %, and with particular preference not more than 15 wt %.

In the context of the present invention it has emerged in certain cases that the addition of amines to the latent alkylborane may carry particular advantages, particularly if these amines promote the curing of the radically curable substance. Thus an additional amine may react, for example, with a peroxide or hydroperoxide that is used in the radically curable composition, and may thus accelerate curing of the radically curable composition. Suitable amines in this context are, for example, aromatic aniline derivatives, such as, in particular, N,N-diethylaniline, hydroxyethylated anilines, such as N,N-bis(2-hydroxyethyl)-p-toluidine (Bisomer PTE), and halogenated derivatives thereof. Particularly suitable amines for use with hydroperoxides are amine-aldehyde condensation products such as, for example, 3,5-diethyl-1,2-dihydro-1-phenyl-2-propylpyridine (DHP). The addition of corresponding amines to the latent alkylborane may therefore improve the adhesion to elastic substrates, such as EPDM or SBR.

As already elucidated above, the latent alkylborane may be activated by a decomplexing agent. The decomplexing agent may be present in the composition comprising the at least one latent alkylborane, in a composition for separate application, or in the radically curable adhesive. Preferably, however, the decomplexing agent is not present in the composition comprising the at least one latent alkylborane, since this can lead to premature activation of the latent alkylborane which would therefore be wholly or partially degraded. If the decomplexing agent is applied together with the latent alkylborane, therefore, the agent ought not to be mixed with the latent alkylborane until shortly before application. It is preferred, however, if the decomplexing agent is in the radically curable adhesive, since in that case the latent alkylborane is activated only on contact with the radically curable adhesive. It is also possible, though, for the decomplexing agent to be applied as a separate component, after the application of the latent alkylborane, to the layer resulting therefrom, this representing a second pretreatment.

It may be necessary to facilitate the cleaving of the latent alkylborane by heating the composition comprising the latent alkylborane, or the substrate to which said composition has been applied, to a certain temperature.

The decomplexing agent comprises or consists substantially of mineral acids, organic acids, Lewis acids, isocyanates, acyl chlorides, sulfonyl chlorides, aldehydes, or a combination thereof. Organic acids suitable as decomplexing agents are, for example, acids of the general formula R—COOH, wherein R may be hydrogen, an alkyl group having 1 to 20, preferably 1 to 11, and more preferably 1 to 4 carbon atoms, or an aryl group having 6 to 10, preferably 6 to 8, carbon atoms. Likewise suitable are di-functional acids, examples being maleic acid or itaconic acid. The alkyl group may be a straight-chain or branched alkyl. It may be unsaturated or saturated. Exemplary acids include acrylic acid, methacrylic acid, acetic acid, benzoic acid, and p-methoxybenzoic acid. Examples of suitable Lewis acids are SnCl₄, TiCl₄ and the like. Examples of suitable mineral acids are HCl, H₂SO₄, H₃PO₄, and the like. Other suitable decomplexing agents are copolymerizable decomplexing agents, such as, for example, zinc di(meth)acrylate (available for example under the tradenames Dymalink 705 and Dymalink 708), calcium di(meth)acrylate, or hydroxyethyl (meth)acrylate phosphate (available for example under the tradenames Sartomer SR9051, 9050 or 9054).

In the context of the present invention, it has proven particularly useful to use bifunctional decomplexing agents, which have both an unsaturated unit and an acid function. Via the acid function, such compounds act as decomplexing agents for the latent alkylborane, whereas the unsaturated unit allows the decomplexing agent to be incorporated into the radically curable substance. As a result, emergence of the decomplexing agent from the cured substance over time can be prevented. Particularly suitable decomplexing agents in this context are unsaturated carboxylic acids such as acrylic or methacrylic acid, itaconic acid, maleic acid, or monoadducts of hydroxy-functional (meth)acrylates such as hydroxyethyl methacrylate and dicarboxylic acids or their anhydrides such as succinic anhydride, for example.

The decomplexing agent may be present in a concentration high enough for at least part of the latent alkylborane present in the composition to react with the decomplexing agent. It is preferably added in an amount which corresponds at least to approximately 20 mol %, more preferably at least approximately 50 mol %, more particularly at least approximately 80 mol %, and most preferably at least approximately 100 mol %, based on the molar amount of the organic boron compound. For adhesives to be applied as part of a further processing operation and themselves containing latent alkylboranes and decomplexing agents, it should be ensured here that the amount of decomplexing agent present in the adhesive is generally tailored to the amount of latent alkylborane present. A consequence of this is that the amount of decomplexing agent available is not sufficient for reaction with the latent alkylborane applied to the substrate, particularly since latent alkylborane and decomplexing agent mix with another and are able to react even before the adhesive is applied to the substrate. For calculating the above mol % figures, therefore, it is necessary first to subtract the molar amount of the latent alkylborane present in the adhesive from the molar amount of the decomplexing agent, and to calculate the amount of decomplexing agent from the latent alkylborane applied to the substrate and from this corrected decomplexing agent content.

The decomplexing agent may be present, for example, in a concentration of more than 0.05 wt %, preferably more than 0.5 wt %, more preferably more than approximately 1 wt %, and most preferably more than approximately 2 wt %, based on the total weight of the composition. The decomplexing agent may alternatively be present in a concentration of less than approximately 15 wt %, preferably less than approximately 10 wt %, more preferably less than approximately 7 wt %, and most preferably less than approximately 6 wt %, based on the total weight of the composition. It is likewise possible to use mixtures of two or more decomplexing agents, in which case the total weight of all decomplexing agents is within the ranges identified above.

As far as the acrylate-based adhesive is concerned, the present invention is not subject to any relevant restrictions. Preferred examples of acrylates and methacrylates encompass methyl (meth)acrylate, butyl (meth)acrylate, tert-butyl (meth)acrylate, 2-ethylhexyl (meth)acrylate, ethyl (meth)acrylate, isobornyl (meth)acrylate, cyclohexyl (meth)acrylate, benzyl (meth)acrylate, phenoxyethyl (meth)acrylate, lauryl (meth)acrylate, hydroxyethyl (meth)acrylate, glycidyl (meth)acrylate, tetrahydrofurfuryl (meth)acrylate, alkoxytetrahydrofurfuryl (meth)acrylate (e.g. ethoxylated or propoxylated tetrahydrofurfuryl (meth)acrylate), acrylamide, N-methylacrylamide, and (meth)acrylates containing acetal groups such as isopropylideneglycerol (meth)acrylate, glycerol formal (meth)acrylate, or (5-ethyl-1,3-dioxan-5-yl)methyl (meth)acrylate. It has emerged that (meth)acrylates which exhibit a purely aliphatic alkyl radical show less favorable adhesion properties than (meth)acrylates having nonaliphatic constituents such as aromatics or ether groups. In one particularly preferred embodiment, therefore, the acrylate-based adhesive does not exclusively contain (meth)acrylates having nonaliphatic constituents. Especially preferred (meth)acrylates present in the acrylate-based adhesive are, in particular, tetrahydrofurfuryl (meth)acrylate, benzyl (meth)acrylate, and phenoxyethyl (meth)acrylate. The composition preferably comprises one, two or more of the above-stated (meth)acrylates.

In the context of the method described above it has emerged that acrylate adhesives based on trimethylcyclohexyl (meth)acrylate display only a relatively minor improvement in the adhesion following the application of a latent alkylborane. In the context of the present invention, therefore, it is preferred if the acrylate-based adhesive is not based on trimethylcyclohexyl (meth)acrylate, in other words that this (meth)acrylate does not constitute the main fraction (in moles) of the (meth)acrylate constituents. The acrylate-based adhesive preferably contains trimethylcyclohexyl (meth)acrylate in a maximum amount of 10 wt %, preferably 5 wt %, and more particularly 1 wt % (based in each case on the total weight of the composition). In one particularly preferred embodiment, the acrylate-based adhesive contains no trimethylcyclohexyl (meth)acrylate.

In addition to the above-described (meth)acrylate monomers, the acrylate-based adhesive may have further radically polymerizable constituents. These are, for example, crosslinking monomers such as allyl (meth)acrylate or crosslinking (meth)acrylates with a functionality of two or higher, such as oligomeric or polymeric compounds of the formula (I).

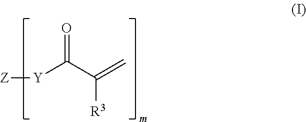

The radical R³ in this formula is a hydrogen atom or is a methyl group. The index m is a value from 2 to 5. Moreover, Z is a polyol, more particularly a polyester polyol, a polycarbonate polyol or a polyether polyol, such as polyethylene glycol or propylene glycol, after removal of m hydroxyl groups, and Y is O or is NR′, where R′ is a hydrocarbyl radical or is a hydrogen atom, and preferably is a hydrogen atom.

The compound of the formula (I) is in particular selected from the group consisting of ethylene glycol di(meth)acrylate, 1,3- and 1,4-butanediol di(meth)-acrylate, 1,6-hexanediol di(meth)acrylate, ethoxylated and propoxylated neo-pentyl glycol di(meth)acrylate, propoxylated glyceryl tri(meth)acrylate, trimethylolpropane tri(meth)acrylate, trimethylolpropane di(meth)acrylate, ethoxylated trimethylolpropane tri(meth)acrylate, modified pentaerythritol tri(meth)acrylate, propoxylated ethoxylated pentaerythritol tetra(meth)acrylate, ditrimethylolpropane tetra(meth)acrylate, and dipentaerythritol penta-(meth)acrylate. In particular, m in the compound of the formula (I) is a value of 2 and Z is a polymeric polyol after removal of two OH groups. This polymeric polyol is more particularly a polyalkylene polyol, a polyoxyalkylene polyol or a polyurethane polyol; a polyhydroxy-functional ethylene-propylene-diene, ethylene-butylene-diene or ethylene-propylene-diene copolymer; a polyhydroxy-functional copolymer of dienes such as 1,3-butanediene or diene mixtures and vinylmonomers such as styrene, acrylonitrile or isobutylene; a polyhydroxyfunctional polybutadiene polyol; a polyhydroxy-functional acrylo-nitrile/butadiene copolymer; or a polysiloxane polyol.

Di- or trifunctional (meth)acrylates of these kinds are selected for example from the group consisting of polyethylene glycol di(meth)acrylate such as diethylene glycol di(meth)acrylate, triethylene glycol di(meth)acrylate, tetraethylene glycol di(meth)acrylate; polypropylene glycol di(meth)acrylate such as dipropylene glycol di(meth)acrylate, tripropylene glycol di(meth)acrylate; and tris(2-hydroxy-ethyl)isocyanurate tri(meth)acrylate.

With further suitability Z is a diphenol, more particularly an alkoxylated diphenol, after removal of two OH groups, preferably ethoxylated bisphenol A. A difunctional (meth)acrylate of this kind is available commercially, for example, under the tradename Sartomer® SR 348 from Sartomer Company, Inc., USA.

Examples of other suitable further constituents of the radically curable substance include difunctional (meth)acrylates such as epoxy (meth)acrylates, more particularly epoxy (meth)acrylates which are obtainable from the reaction of bisphenol A diglycidyl ether with (meth)acrylic acid. A difunctional (meth)acrylate of this kind is available commercially, for example, under the tradename Sartomer® CN 104 from Sartomer Company, Inc., USA.

Likewise possible for use is the class of the vinyl-functionalized prepolymers. These are prepolymers which are functionalized terminally with vinyl groups in the form, for example, of (meth)acrylate groups. Suitable vinyl-functionalized prepolymers are based, for example, on polyhydroxy-terminated acrylonitrile/butadiene copolymers and are typically prepared from carboxy-terminated acrylonitrile/butadiene copolymers, which are available commercially, for example, under the name Hypro® CTBN from Emerald Performance Materials, LLC, USA, and from epoxides or amino alcohols.

Suitable vinyl-functionalized prepolymers of the formula (I) of this kind are available commercially, for example, from Kraton Polymers, USA, or under the tradenames Hypro® VTB and Hypro® VTBNX from Emerald Performance Materials, LLC, USA. Another example of vinyl-functionalized prepolymers are acrylate-capped polybutadiene prepolymers (oligomers, for example), which are available commercially, for example, from Emerald Performance Materials under the tradename Hypro. One such preferred compound is Hypro™ VTB 2000X168.

The vinyl-functionalized prepolymer may also be a polyurethane (meth)acrylate. Compounds of this kind are preparable typically, in a manner known to a person skilled in the art, from the reaction of at least one polyisocyanate, more particularly a diisocyanate, and of a (meth)acrylic acid, a (meth)acrylamide or a (meth)acrylic ester which has a hydroxyl group or amine group. Prior to the reaction with (meth)acrylic acid, a (meth)acrylamide or a (meth)acrylic ester which has a hydroxyl group or amine group, the diisocyanate may optionally be reacted with at least one polyol, more particularly a diol, in a process known to a person skilled in the art, to form a polyurethane polymer having isocyanate groups.

Particularly suitable for reaction with the isocyanate groups of the polyisocyanate are hydroxyalkyl (meth)acrylates such as hydroxypropyl-acrylate (HPA), hydroxypropyl methacrylate (HPMA), hydroxybutyl acrylate (HBA) or hydroxybutyl methacrylate (HBMA), preferably hydroxyethyl acrylate (HEA) or hydroxyethyl methacrylate (HEMA), or a monohydroxy poly(meth)acrylate of a polyol, preferably of glycerol or trimethylolpropane.

Polyurethane (meth)acrylates may likewise be prepared by esterification of a polyurethane polymer containing hydroxyl groups with (meth)acrylic acid.

Furthermore, polyurethane (meth)acrylates may be prepared by the reaction of a (meth)acrylic ester having at least one isocyanate group with a polyurethane polymer containing hydroxyl groups or with a polyol, of the kind described, for example, in the present document. A suitable example of a (meth)acrylic ester having at least one isocyanate group is 2-isocyanatoethyl methacrylate.

Suitable polyisocyanates are commercial polyisocyanates, especially diisocyanates. Suitable diisocyanates, for example, are hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, lysine diisocyanate and lysine ester diisocyanate, cyclohexane 1,3-diisocyanate, cyclohexane 1,4-diisocyanate, 1-isocyanato-3,3,5-trimethyl-5-isocyanatomethylcyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethylxylylene 1,3-diisocyanate, m- and p-tetramethylxylylene 1,4-diisocyanate, bis(1-isocyanato-1-methylethyl)naphthalene, toluylene 2,4- and 2,6-diisocyanate (TDI), 4,4′-, 2,4′- and 2,2′-diphenylmethane diisocyanate (MDI), phenylene 1,3- and 1,4-diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODD, oligomers and polymers of the aforementioned isocyanates, and also any desired mixtures of the aforementioned isocyanates.

Suitable polyols are, in particular, polyether polyols, polyester polyols and polycarbonate polyols, and also mixtures of these polyols. Suitable polyols are, for example, polyols listed as polyols P in European patent application EP 08169631.2, the entire disclosure content of which is hereby incorporated by reference.

The polyol is preferably a diol, more particularly polyoxypropylene diol or polyoxybutylene diol. Most preferably the polyols are polyols which are as apolar as possible.

One preferred acrylate-capped polyurethane prepolymer is CN 973J75 from Sartomer Company, Inc.

Other prepolymers which can be used in the context of the present invention are those which are prepared from polyols, such as polypropylene glycol, polyethylene glycol or polytetrahydrofuran, for example. It is also possible to use mixtures of different polyols as a basis for the acrylate-capped prepolymers, such as, for example, a mixture of polypropylene glycol and polytetrahydrofuran, or of polytetrahydrofuran and polyesters.

The vinyl-functionalized prepolymer is preferably an elastomer, more particularly a polyurethane (meth)acrylate and/or a vinyl-terminated acrylonitrile/butadiene copolymer.

The radically curable adhesive may consist of one of the aforementioned components. Preferably, however, the radically curable adhesive comprises a combination of two, three or more components which can be cured by means of a radical polymerization. Without being tied to any particular theory, the use of, for example, two or more acrylates or methacrylates affords compositions which have one or more different advantageous properties, such as, for example, different wetting properties, different surface energies, different reactivities, different adhesive properties, or different fracture properties.

It may also be sensible to incorporate further radically curable components, not based on acrylates or methacrylates, into the radically curable adhesive, in addition to acrylates and/or methacrylates. Such additional components may be added generally in the form of monomers, oligomers, or as prepolymers. Examples of such components are styrene and alkylated styrene varieties (e.g., methylstyrene), allyl compounds, vinyl compounds, methallyl compounds, etc. It is preferred, however, if the amount of such additional monomers in the radically curable adhesive, if said adhesive comprises substantially acrylates or methacrylates, is less than about 40%, more particularly less than about 30%, very preferably less than about 20%, and most preferably less than about 10%, based on the total weight of the radically curable monomers in the acrylate-based adhesive.

The amount of radically curable constituents, i.e., of monomers and optionally oligomers and/or prepolymers, in the radically curable adhesive is preferably about 10 wt % or more, more preferably about 15 wt % or more, more preferably still about 20 wt % or more, and most preferably about 30 wt % or more, based on the total weight of the radically curable adhesive. The content of compounds which can be polymerized by free radical polymerization is preferably about 90 wt % or less, based on the total radically curable adhesive, more preferably about 85 wt % or less, and most preferably about 80 wt % or less. In the case of injection adhesives, the monomer fraction may also be higher, in the range from 90 to 95 wt %, for example, based on the total weight of the radically curable adhesive.

In an example which, however, is not intended to be restricting on the present invention, the radically curable adhesive may comprise one, two, three or four compounds selected from the group consisting of methyl (meth)acrylate, tetrahydrofurfuryl (meth)acrylate, lauryl (meth)acrylate, benzyl (meth)acrylate, phenoxyethyl (meth)acrylate, an acrylate or methacrylate having an epoxide ring, an acrylate or methacrylate having an acetal group, such as isopropylideneglycerol (meth)acrylate, glycerol formal (meth)acrylate or (5-ethyl-1,3-dioxan-5-yl)methyl (meth)acrylate, and an acrylate- or methacrylate-capped alkanediene (butadiene, for example) prepolymer.

The radically curable adhesive may also comprise one or more fillers. In a two-component polymerizable composition, the filler may be contained in the first component or in the second component or in both components. It has been observed that compositions which comprise two or more fillers exhibit surprisingly good adhesiveness to the substrates.

The fillers which can be used in the polymerizable composition include talc, mica, wollastonite, calcium carbonate, barium sulfate, magnesium carbonate, clay, aluminum dioxide, silicon dioxide, fumed silica, calcium sulfates, carbon fibers, glass fibers, metal fibers, silica sand, activated carbon, titanium dioxide, magnesium hydroxide, zeolite, molybdenum, kieselguhr, sericite, white sand, calcium hydroxide, calcium sulfite, sodium sulfate, bentonite, graphite, glass particles, glass beads, nanoparticles of clay, kaolinite, illite, smectite, sepiolite, vermiculite, pyrophyllite, sauconite, saponite, nontronite, montmorillonite, magnesium aluminum silicate, metal carbonates, feldspar, mica, quartz, and mixtures thereof. Suitable fillers may be treated or untreated. Exemplary fillers include, without restriction, talc, calcium carbonate, fumed silica, clay, or a combination thereof. Two or more of these fillers may be used. For example, the polymerizable composition may comprise fumed silica and a treated (or untreated) calcium carbonate.

Additionally, it is possible for organic fillers to be incorporated into the polymerizable composition. Examples of suitable organic fillers are those which have elastomeric or impact-strength-improving properties. Examples of such fillers are core-shell polymers, such as MBS or AIM types, for example, which are available under the tradenames Durastrength® or Clearstrength® from Arkema, under the tradename Paraloid® from Dow Chemical, or Blendex® from KaneAce, for example. Other organic fillers which can be used are elastomers based on SBS block copolymers and the like (available, for example, under the tradename Kraton), and also chlorosulfonated polyethylenes, which are available, for example, under the tradename Tosoh CSM.

The filler may be used in a concentration of about 0 wt % or more, preferably about 5 wt % or more, and more preferably about 10 wt % or more, based on the total weight of the acrylate-based adhesive. The filler may be used in a concentration of about 50 wt % or less, preferably about 40 wt % or less, more preferably about 30 wt % or less, and most preferably about 25 wt % or less, based on the total weight of the polymerizable composition. For example, the filler may be present in a concentration of about 0 wt % to 50 wt %, preferably of about 5 wt % to about 40 wt %, and more preferably of about 10 to about 30 wt %, based on the total weight of the polymerizable composition.

Inorganic fillers are included in the polymerizable composition preferably in an amount of about 0 to 40%, whereas organic fillers are present preferably in an amount in the range from 0 to 50% in the polymerizable composition.

For the purposes of the method described above, the radically curable adhesive for incorporation, and more particularly the acrylate-based adhesive, usefully has an open time in the range from 3 to 45 minutes. Open time here refers to the time within which the adhesive has a wetting property for the substrate or substrates that is sufficient for adhesive bonding.

So that the positioning of the joining strip ends in the case of the joining strip substrates (1) and (2) cannot alter during bonding, it is useful to fasten these ends prior to bonding. For this purpose, the joining strip ends can be clamped, for example, in a corresponding holding device, which can be removed after the adhesive has cured.

With certain radically curable adhesives, moreover, the problem exists that the polymerization of the monomers of the surface of the adhesive, which is in contact with air, is associated with secondary reactions, an example being incorporation of oxygen into the polymer which forms. For this reason, with certain radically curable adhesives, “greasy” surfaces develop in the course of curing under air contact (and accordingly, contact with oxygen), these surfaces not being cured all the way through. In the context of the present invention, therefore, it is preferred if the processing and the curing of the adhesive take place in the absence of oxygen.

In one particularly preferred embodiment, for this purpose, prior to the application of the acrylate-based adhesive, the joining strip substrate (1) and preferably likewise the joining strip substrate (2) are provided with an airtight envelope. One example of an envelope of this kind is a sleeve which has an inlet for the addition of the adhesive and an outlet for the emergence of air located within the sleeve. The radically curable adhesive is subsequently introduced into the airtight envelope, and so is able to contact the joining strip substrate (1) and the joining strip substrate (2), whereas air contact of the adhesive is possible, for example, only in the region of the outlet and, optionally, in the region of the inlet of the sleeve into which the adhesive is introduced. Following complete curing, the airtight envelope can be removed again from the resultant adhesive bond. Because contacting and/or application of the composition containing the latent alkylborane is more difficult when the joining strip substrates have been provided with an airtight envelope, it is useful for this composition to be applied to the joining strip substrate or substrates even before the placement of the airtight envelope.

For the method described, moreover, it is preferred if the joining strip ends of the joining strip substrates (1) and (2) are fastened in a holding device before the radically curable adhesive is applied. For this purpose, the aforementioned sleeve is usefully configured in such a way that fastening of the joining strip ends is possible as well as the provision of an airtight envelope.

A further aspect of the present invention relates to bonded joining strips which are obtainable by a method as elucidated above.

The present invention likewise relates to a joining system which consists of
i) a composition which comprises at least one latent alkyborane and is substantially free of decomplexing agents for the latent alkylborane, as described above, and
ii) a radically curable adhesive.

For preferred embodiments of the latent alkylborane and of the radically curable adhesive, the details given above are valid analogously.

A further aspect of the present invention relates to the use of a composition which comprises a latent alkylborane as described above as activator for the bonding of joining strips, preferably of EPDM and SBR joining strips. For the composition, the statements made above for preferred embodiments of the latent alkylborane are valid analogously.

The term “activator” in connection with the present invention means that the composition is used for pretreatment of the substrate and is itself substantially free of decomplexing agents. The composition of the activator is generally different from that of an adhesive. “Substantially” as used above should be interpreted to mean that the composition contains less than about 5 wt %, preferably less than about 2 wt %, of decomplexing agents, and more preferably none.

In connection with the above-described method, the bonded joining strips, and the designated use, it has surprisingly emerged that pretreatment of PVC substrates with compositions which comprise at least one latent alkylborane and are substantially free of decomplexing agents for the latent alkylborane is not automatically necessary. The present patent application, accordingly, also encompasses a method for connecting PVC joining strips that comprises a) applying a radically curable adhesive to the PVC joining strip substrate (1), b) contacting the joining strip substrate (1) from a) with a joining strip substrate (2) in such a way that the radically curable adhesive is disposed between the two substrates, and also c) allowing the acrylate adhesive to cure to form a composite structure, without this method including the application to the joining strip substrate (1) of a composition which comprises at least one latent alkylborane and is substantially free of decomplexing agents for the latent alkylborane. Particularly preferred radically curable adhesives in this context are acrylate-based adhesives and, more particularly, adhesives based on methyl (meth)acrylate, tetrahydrofurfuryl (meth)acrylate, benzyl (meth)acrylate, isopropylideneglycerol (meth)acrylate, glycerol formal (meth)acrylate or (5-ethyl-1,3-dioxan-5-yl)methyl (meth)acrylate, i.e., adhesives which, based on the total amount of radically curable monomers, contain 35 wt % or more, preferably 50 wt % or more, of the stated (meth)acrylates. Most preferred in this context are adhesives based on methyl methacrylate.

Analogously, the present invention also covers joining strips bonded accordingly.

The foregoing invention provides a simple and cost-effective method enabling the bonding of joining strips, particularly those made from materials that are otherwise difficult to bond, such as EPDM or SBR. In contrast to the prior art, this method is associated with the advantages of extended open times, shortened cure times, and improved storage stabilities on the part of the adhesives used. Furthermore, bonding can be carried out using commercially available adhesives, and so the stated materials can be bonded in an inexpensive way.

It has surprisingly been found, moreover, that the adhesive bonds obtained by the method described exhibit extremely good bond stability even on storage in highly alkaline solutions such as fresh concrete or concrete pore liquid. This observation is not obvious, particularly for acrylate-based adhesives with a significant fraction of acrylate esters, since these esters undergo hydrolysis at high pH levels, and so, consequently, there is failure of the adhesive bond or at least a substantial diminishment of the assembly strengths.

A further aspect of the present invention relates, therefore, to a method for sealing a construction, comprising a) applying a composition which comprises at least one latent alkylborane and is substantially free of decomplexing agents for the latent alkylborane to a joining strip substrate (1), b) applying a radically curable adhesive to the joining strip substrate (1) pretreated with the latent alkylborane, c) contacting the joining strip substrate (1) from b) with a joining strip substrate (2) such that the radically curable adhesive is disposed between the two substrates, d) allowing the radically curable adhesive to cure to form a composite structure, and e) contacting the bonded joining strip composite structure with liquid concrete, fresh concrete or concrete pore liquid.

In the text below, the present invention is described using a number of illustrative examples which should be regarded in some way as authoritative for the scope of protection of the patent application.

### Example 1

A composition made up of 90 parts by weight of ethyl acetate and 10 parts by weight of tri-n-butylborane/methoxypropylamine complex (BASF) was applied to various joining strip substrates. For the measurement, the composition was applied by means of a brush. Following application of the composition and evaporation for a period of 15 to 30 minutes, the alkylborane-amine complex remained in a film thickness of about 2 μm on the substrate. The adhesive (SikaFast 5211 NT) was subsequently applied to the treated area, in a film thickness as specified below. This adhesive includes calcium dimethacrylate as a decomplexing agent.

Substrates employed were a PVC substrate (AF-600 from Sika), an EPDM substrate (FPK 350 from Sika Tricosal Illertissen), and an SBR substrate (from extrutec Gummi GmbH).

The mechanical properties of the adhesive bond were determined by means of the following test protocols.

### T-Peel

The T-peel test was carried out in a method based on DIN EN 14173 at a testing velocity of 100 mm/min. The substrates used were strips of the respective material having the following dimensions: length 150 mm, width 40 mm, height 4 mm (PVC), 5 mm (EPDM), and 6 mm (SBR). The adhesive was applied in a thickness of 0.3 mm.

### Tensile Lap Shear Strength

The tensile lap shear strength was determined in a method based on DIN EN 1465 at a testing velocity of 10 mm/min.

The substrates used were strips of the respective material having the following dimensions: length 100 mm, width 25 mm, height 4 mm (PVC), 5 mm (EPDM), and 6 mm (SBR). The adhesive was applied in a thickness of 1.5 mm.

### Tensile Strength

The tensile strength was determined in a method based on DIN EN ISO 527 at a testing velocity of 100 mm/min.

The substrates used were strips of the respective material having the following dimensions: length 70 mm, width 25 mm, height 4 mm (PVC), 5 mm (EPDM), and 6 mm (SBR). The adhesive was applied in a thickness of 1.0 mm.

For the different samples, the properties were determined after curing of the adhesive (initial) and also after 7 days of storage in water and saturated calcium hydroxide in each case at 23° C. In addition, the proportion (in %) of substrate fracture (SB), cohesive failure (KB), and adhesive failure (AB) was determined visually. The results of the measurements are recorded in tables 1 to 3 below.

TABLE 1
EPDM

| | Without borane | With borane |
|---|---|---|
| | activator | activator |
| T-Peel | | |
| Initial | 5.9 | 8.9 |
| | 70% SB | 70% SB |
| 7 d in water/23° C. | 11.3 | 11.9 |
| | 100% SB | 100% SB |
| 7 d in sat. | 11.6 | 8.3 |
| Ca(OH)₂/23° C. | 100% SB | 100% SB |
| Tensile lap shear | | |
| strength | | |
| Initial | 2.8 | 3.4 |
| | 100% SB | 100% SB |
| Tensile strength | | |
| Initial | 4.6 | 5.6 |
| | 50% SB/50% AB | 100% SB |
| 7 d in water/23° C. | 4.0 | 5.6 |
| | 100% SB | 100% SB |
| 7 d in sat. | 4.0 | 5.1 |
| Ca(OH)₂/23° C. | 100% SB | 100% SB |

TABLE 2
PVC

| | Without borane | With borane |
|---|---|---|
| | activator | activator |
| T-Peel | | |
| Initial | 2.5 | 2.1 |
| | 100% KB | 100% KB |
| Tensile lap shear | | |
| strength | | |
| Initial | 4.1 | 4.3 |
| | 100% SB | 70% SB/30% KB |
| Tensile strength | | |
| Initial | 6.2 | 6.7 |
| | 100% AB | 100% AB |

TABLE 3
SBR

| | Without borane | With borane |
|---|---|---|
| | activator | activator |
| T-Peel | | |
| Initial | 0.1 | 9.9 |
| | 100% AB | 100% SB |
| 7 d in water/23° C. | 0.0 | 10.3 |
| | 100% AB | 100% SB |
| 7 d in sat. | 0.0 | 10.0 |
| Ca(OH)₂/23° C. | 100% AB | 100% SB |
| Tensile lap shear | | |
| strength | | |
| Initial | 0.1 | 4.5 |
| | 100% AB | 100% SB |
| Tensile strength | | |
| Initial | 0.0 | 2.6 |
| | 100% AB | 60% SB/40% AB |
| 7 d in water/23° C. | 0.0 | 1.3 |
| | 100% AB | 100% AB |
| 7 d in sat. | 0.0 | 2.2 |
| Ca(OH)₂/23° C. | 100% AB | 100% AB |

### Example 2

Compositions containing different amounts of organoborane-amine complexes are investigated in respect of the bonding of NBR and SBR rubbers using the adhesive Sika Fast®-5211NT (based on tetrahydrofurfuryl methacrylate). For the test bond, an NBR or SBR substrate, respectively, is treated with an adhesive promoter composition comprising different amounts of triethylborane-diaminopropane complex (in solution in heptane). For the measurement, the adhesion promoter was applied by means of a brush. Following application of the adhesion promoter and evaporation for a period of 15 to 30 minutes, the adhesion promoter remained on the substrate with a film thickness of about 2 μm. The adhesive is subsequently applied to the treated area in a film thickness of 1 mm. The torsional strength of the adhesive bond was determined by the following test protocol:

First of all a round aluminum test specimen (crown-shaped, external diameter 25 mm; internal diameter 15 mm) was roughened with 60-100-grade abrasive paper. A round PTFE spacer was then inserted into this test specimen, and protruded beyond the test specimen and served to set a thickness of adhesive of 1 mm. Then the premixed adhesive was applied to the aluminum shape. The aluminum shape was subsequently pressed by the adhesive side onto a substrate, causing the adhesive to be disposed in the region of the aluminum shape minus the spacer. Excess adhesive, pressed out of the joint when the test specimen was mounted onto the substrate, was removed by means of a spatula. After the adhesive had been cured at 23° C. and 50% relative humidity for 24 hours, a screw was fastened on the aluminum test specimen, serving as a counterpiece and point of attack for the test machine. The test machine was then used to determine the torsional strength, with the testing apparatus measuring the torque on yielding of the adhesive bond, the torsional strength being calculated from this torque. The values reported correspond to the average from three individual measurements.

The results are reproduced in table 4:

TABLE 4

| | | 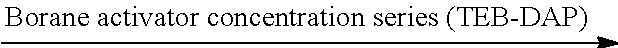 | | | | | | | |
|---|---|---|---|---|---|---|---|---|---|
| NBR | Pretreat- | BO | BO | BO | BO | BO | BO | BO | ADPrep |
| yellow | ment | 0% | 2.5% | 5% | 10% | 15% | 20% | 25% | |
| rubber | Adhesive | 5211NT | 5211NT | 5211NT | 5211NT | 5211NT | 5211NT | 5211NT | 5211NT |
| | Torsional | 0.42 | 5.88 | 5.32 | 6.92 | 6.31 | 4.83 | 6.35 | 0.33 |
| | strength | | | | | | | | |
| | [MPa] | | | | | | | | |
| SBR | Pretreat- | BO | BO | BO | BO | BO | BO | BO | ADPrep |
| black | ment | 0% | 2.5% | 5% | 10% | 15% | 20% | 25% | |
| rubber | Adhesive | 5211NT | 5211NT | 5211NT | 5211NT | 5211NT | 5211NT | 5211NT | 5211NT |
| | Torsional | 1.57 | 3.92 | 3.97 | 4.18 | 3.93 | 2.48 | 2.91 | 1.42 |
| | strength | | | | | | | | |
| | [MPa] | | | | | | | | |

BO = borane complex in solution in heptane, figure in weight percent
TEB-DAP = triethylborane-diaminopropane complex
ADPrep = Sika ® ADPrep (standard primer for 2-component acrylate adhesives)
5211NT = SikaFast ®-5211NT

It is found that with amounts of just 2.5 wt % of triethylborane-diaminopropane complex in the primer, a substantial improvement is possible in the torsional strength of the adhesive, relative to treatment with a standard primer consisting of various monomeric acrylates and dihydroxybenzene and also isopropanol.

1. A method for connecting joining strips, comprising
a) applying a composition which comprises at least one latent alkylborane and is substantially free of decomplexing agents for the latent alkylborane to a joining strip substrate (1),
b) applying a radically curable adhesive to the joining strip substrate (1) pretreated with the latent alkylborane,
c) contacting the joining strip substrate (1) from b) with a joining strip substrate (2) such that the radically curable adhesive is disposed between the two substrates, and
d) allowing the radically curable adhesive to cure to form a composite structure.

2. The method as claimed in claim 1, wherein the joining strip substrate (1) and/or (2) comprises a PVC, EPDM, NBR or SBR substrate, or a substrate composed of mixtures of these materials.

3. The method as claimed in claim 1, wherein the radically curable adhesive is an acrylate-based adhesive.

4. The method as claimed in claim 1, wherein the radically curable adhesive comprises one or more monomers selected from tetrahydrofurfuryl (meth)acrylate, benzyl (meth)acrylate or phenoxyethyl (meth)acrylate.

5. The method as claimed in claim 1, wherein the composition which comprises the latent alkylborane further comprises a (meth)acrylate monomer.

6. The method as claimed in claim 1, wherein the composition comprising at least one latent alkylborane has a pH of approximately 7 or more.

7. The method as claimed in claim 1, wherein the composition comprising at least one latent alkylborane further comprises a solvent.

8. The method as claimed in claim 1, wherein the concentration of the at least one latent alkylborane in the composition is approximately 2.5 to 30 wt %.

9. The method as claimed in claim 1, wherein the latent alkylborane is in the form of a trialkylborane-amine complex in which the alkyl groups are identical or different and have 1 to 11 carbons.

10. The method as claimed in claim 9, wherein the amine in the trialkylborane-amine complex is in the form of an alkylamine having at least one primary amino group, in which the alkyl group contains carbon atoms and may contain ether oxygens.

11. The method as claimed in claim 1, wherein the joining strip substrate (1) and the joining strip substrate (2) are provided with an airtight envelope before the radically curable adhesive is applied, the radically curable adhesive is introduced into this airtight envelope, and the joining strip ends of the joining strip substrates (1) and (2) are fixed in a holding apparatus before the radically curable adhesive is applied.

12. A bonded joining strip obtainable by a method as claimed in claim 1.

13. A joining system consisting of
i) a composition which comprises at least one latent alkylborane and is substantially free of decomplexing agents for the latent alkylborane, as described in claim 1, and
ii) a radically curable adhesive.

14. A method comprising activating of joining strips for bonding with radically curable adhesives by at least one latent alkylborane and is substantially free of decomplexing agents for the latent alkylborane.

15. A method for sealing a construction, comprising
a) applying a composition which comprises at least one latent alkylborane and is substantially free of decomplexing agents for the latent alkylborane to a joining strip substrate (1),
b) applying a radically curable adhesive to the joining strip substrate (1) pretreated with the latent alkylborane,
c) contacting the joining strip substrate (1) from b) with a joining strip substrate (2) such that the radically curable adhesive is disposed between the two substrates,
d) allowing the radically curable adhesive to cure to form a composite structure, and
e) contacting the bonded joining strip composite structure with liquid concrete, fresh concrete or concrete pore liquid.
